(19) United States
(12) Patent Application Publication
(10) Pub. No.: US 2009/0268057 A1
(43) Pub. Date: Oct. 29, 2009

(54) Portable memory device with wireless communication capability

(75) Inventor: Yu-Chung Wang, Taipie City (TW)

Correspondence Address: BACON & THOMAS, PLLC, 625 SLATERS LANE, FOURTH FLOOR, ALEXANDRIA, VA, 22314-1176, US

(73) Assignee: Home Scenario Inc., Taipei City (TW)

(21) Appl. No.: 12/081,964

(22) Filed: Apr. 24, 2008

(51) Int. Cl. H04N 5/77

(52) U.S. Cl. 348/231.6; 348/375

(57) ABSTRACT

The present invention is to provide a portable memory device with wireless communication capability which comprises a controller connected with an input/output interface for connecting with a digital photographic device, a first storage unit for saving photographs and photographic information received from the digital photographic device through the input/output interface, a wireless communication module for establishing a wireless transmission path with a wireless communication module of an environmental information recording device and second storage unit for saving environmental information received from the environmental information recording device through the wireless transmission path respectively. Thus, while a user taking photos by using the digital photographic device, the photos, photographic information and environmental information may at the same time be saved to the first and second storage units respectively, enabling the user to learn about the environmental information while the photos were taken at a later time.

### FIELD OF THE INVENTION

The present invention relates to a portable memory device, more particularly to a portable memory device with wireless communication capability capable of receiving environmental information transmitted by an environmental information recording device while receiving photographs and photographic information generated by a digital photographic device.

### BACKGROUND OF THE INVENTION

In the past, when a user taking photos by using a conventional photographic device, only limited information like time and date is appended to the photos, there is no way for the user to learn about photographic information (such as the time of exposure, f-number, ISO sensitivity and resolution etc.), weather information like temperature and humidity, or detailed geographic information (such as GPS information) after the photos were taken, and the only way of organizing the photos is according to the time of taking the photos. In case a user wants to append the environmental information (such as the temperature, humidity, illumination and GPS information etc.) and photographic information (such as the time of exposure, f-number, ISO sensitivity and resolution etc.) to the photos being taken, the user has to measure and record said information manually while taking photos which is inconvenient, time-consuming and with high possibility of data loss due to carelessness.

As a result, the Japan Electronics and Information Technology Industries Association (JEITA) has developed an Exchangeable Image File Format (EXIF for short) in 1996 which enables a photographic device to record the photographic information automatically while photos being taken by using the photographic device. And due to the EXIF file may be appended to a image file like a JPEG, TIFF or RIFF file etc., the user may retrieve the photographic information in the file by using the software developed for the EXIF file which effectively improves the drawbacks of the conventional photographic device and save a lot of time for recording the information by the user. However, though having the above improvements, the photographic device is still unable to automatically record the environmental information (such as the temperature, humidity, illumination, and GPS information etc.) while taking the photos, the user has to do extra measurement and recording works manually taking the photos, which is inconvenient as usual.

To solve the problems stated above, several manufacturers of photographic device (such as Sony and Nikon) have developed GPS tracking devices specially designed for photographic devices. To use said tracking device, first a user is required to synchronize the time of the photographic device and the tracking device, the tracking device will automatically record the time and GPS information while the user taking photos and, in the meanwhile, the photographic device will save the time and photographic information in EXIF files of the photos. Hence, the user may integrate said GPS information into said EXIF files of the photos by using the software provided by the manufacturer. In general, said software will integrate photographic information and GPS information with the same time and generate new photos, thus the GPS information may be easily recorded while taking photos. However, in the case that the time of the photographic device and the tracking device are not synchronized due to carelessness, errors will occur when integrating the photographic information with the GPS information which will cause the photos appended with incorrect information. Besides, if the user is located at a place unable to receive GPS signals (such as in a cave or tunnel), the GPS information corresponding to current location will not be recorded correctly. Moreover, the tracking device is still unable to measure and record the environmental information, such as the temperature, humidity and illumination etc., thus the user has to do extra measurement and recording works manually, which make said tracking device inconvenient and unsuitable for use.

Hence, how to improve the structure of the portable memory device and enable the portable memory device to save photos and photographic information and, at the same time, record environmental information when the portable memory device is connected with a digital photographic device has become an important issue to be solved.

### SUMMARY OF THE INVENTION

For the purpose of solving the problems stated above, after hard work of research and experiments for a long time, the inventor has developed a portable memory device with wireless communication capability which is capable of recording environmental information in a fast and easy way while the user taking photos by using a photographic device.

One of the objectives of the present invention is to provide a portable memory device with wireless communication capability which comprises an input/output interface, a controller, a first storage unit, a second storage unit and a wireless communication module, wherein the controller is connected with the input/output interface, the first and second storage units and the wireless communication module respectively. The input/output interface provides plug connection that the portable memory device may be connected with the digital photographic device through the input/output interface. Alternatively, the input/output interface may allow plug connection with a reading device (such as a card reader) thus enables the portable memory device to be connected with a personal computer through the input/output interface and the reading device. The wireless communication module is capable of establishing a wireless transmission path with a wireless communication module of an environmental information recording device. The controller may receive photographs and photographic information (such as time of exposure, f-number, ISO sensitivity and resolution etc.) generated by the digital photographic device through the input/output interface and save them to the first storage unit. Meanwhile, the controller may receive environmental information transmitted by the environmental information recording device through the wireless transmission path by using the wireless communication module and save it to the second storage unit. Thus, while a user taking photos by using the digital photographic device, the generated photos, photographic information and environmental information may at that time be automatically and immediately saved to the portable memory device, which substantially saves the recording time of the user compared to that of the manual recording and enables the user to learn about the environmental information while the photos were taken at a later time.

Another objective of the present invention is that when the digital photographic device is not in use, the controller is capable of receiving environmental information transmitted by the environmental information recording device through the wireless transmission path by using the wireless communication module regularly and saving the environmental information in the second storage unit. In the case that the controller stops receiving the environmental information, the environmental information recording device and the wireless communication modules may enter a sleep mode for power saving and making the digital photographic device and the environmental information recording device to be used for much longer. Besides, in the case that the user is located at a place unable to receive GPS signals (such as in a cave or tunnel), the controller may use the GPS information acquired beyond the current location as the GPS information while taking photos.

Another objective of the present invention is that when connected with a reading device (such as a card reader), the portable memory device may connect with a personal computer through the input/output interface and the reading device, and the controller may integrate photos, photographic information and environmental information at the same time into new photos and transmit them to the personal computer through the input/output interface and the reading device, enabling the user to learn about the environmental information while the photos were taken.

### BRIEF DESCRIPTION OF THE DRAWINGS

The foregoing aspects, as well as many of the attendant advantages and features of the present invention will become more apparent by reference to the following detailed description, when taken in conjunction with the accompanying drawings, wherein:

FIG. 1 shows the structure of a preferred embodiment of the present invention;

FIG. 2 is a flow diagram of a first embodiment of the present invention;

FIG. 3 is a flow diagram of a second embodiment of the present invention; and

FIG. 4 shows the structure of a third preferred embodiment of the present invention.

### DETAILED DESCRIPTION OF THE PREFERRED EMBODIMENT

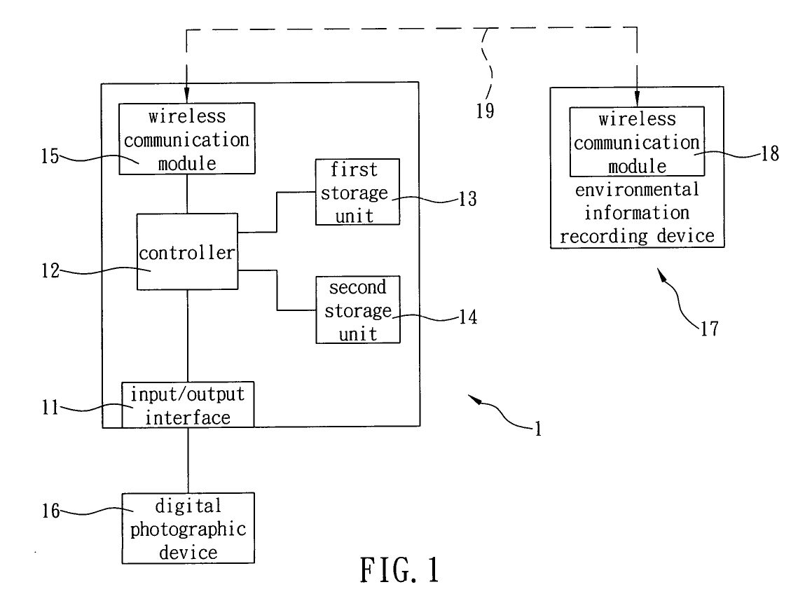

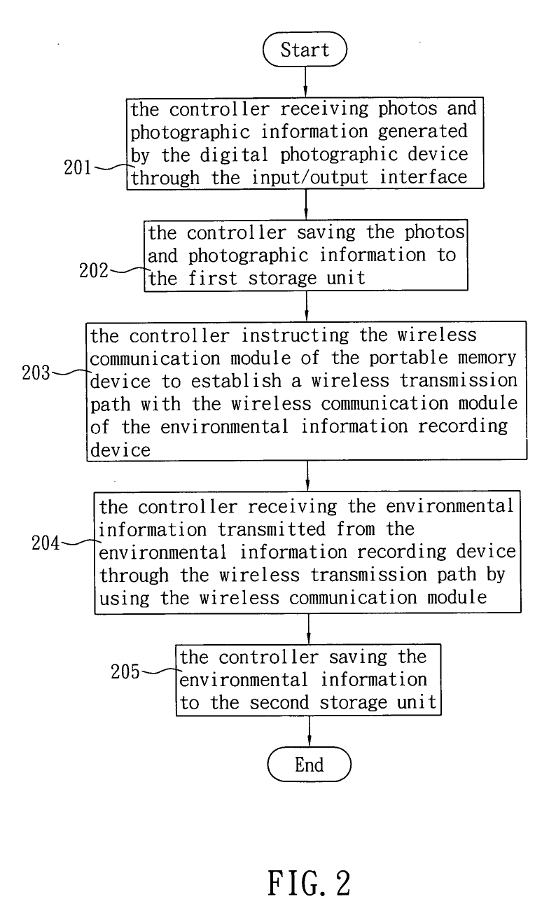

According to a first preferred embodiment of the present invention, a portable memory device with wireless communication capability is provided. Please refer to FIG. 1, the portable memory device 1 comprises an input/output interface 11, a controller 12, a first storage unit 13, a second storage unit 14 and a wireless communication module 15, wherein the controller 12 is connected with the input/output interface 11, the first and second storage units 13 and 14 and the wireless communication module 15 respectively. The input/output interface 11 is to provide a plug connection with a digital photographic device 16 (such as a digital camera or digital video camera) and the portable memory device 1 may be connected with the digital photographic device 16 through the input/output interface 11. The wireless communication module 15 is capable of establishing a wireless transmission path 19 with a wireless communication module 18 of an environmental information recording device 17 (such as a global positioning system, thermometer, hygrometer or illuminance meter etc.). Please refer to FIG. 2, When a plug connection is established between the portable memory device 1 and the digital photographic device 16 and the user starts taking photos, the controller 12 instantly and automatically saves photos and photographic information generated by the digital photographic device 16 as well as environmental information to the portable memory device 1 by following steps of:
(201) the controller 12 receiving a photo and photographic information generated by the digital photographic device 16 through the input/output interface 11;
(202) the controller 12 saving the photo and photographic information to the first storage unit 13 and assigning each of them with a number according to the time (using year, month, day, hour and minute like 2007.1128.1203);
(203) the controller 12 instructing the wireless communication module 15 to establish a wireless transmission path 19 with the wireless communication module 18 of the environmental information recording device 17;
(204) the controller 12 receiving environmental information transmitted from the environmental information recording device 17 through the wireless transmission path 19 by using the wireless communication module 15; and
(205) the controller 12 saving the environmental information to the second storage unit 14 and assigning it with a number according to the time (using year, month, day, hour and minute like 2007.1128.1203).

In said first preferred embodiment, photos and photographic information generated by the digital photographic device 16 as well as environmental information may be saved to the portable memory device 1 instantly and automatically while the digital photographic device 16 taking photos, thus there's no need for a user to manually record environmental information. More to be mentioned, the controller 12 assigns numbers to photos, photographic information and environmental information according to the time of taking photos so as to facilitate integration of photos, photographic information and environmental information having the same number into new photos with photographic and environmental information. Thus, the portable memory device 1 is able to save photos, photographic information and environmental information correctly without synchronization of the time of the digital photographic device 16 and the environmental information recording device 17, which prevents errors due to carelessness and achieves the objectives of saving time, substantially increasing efficiency and making it more convenient for the user to learn about the environmental information while photos were taken at a later time.

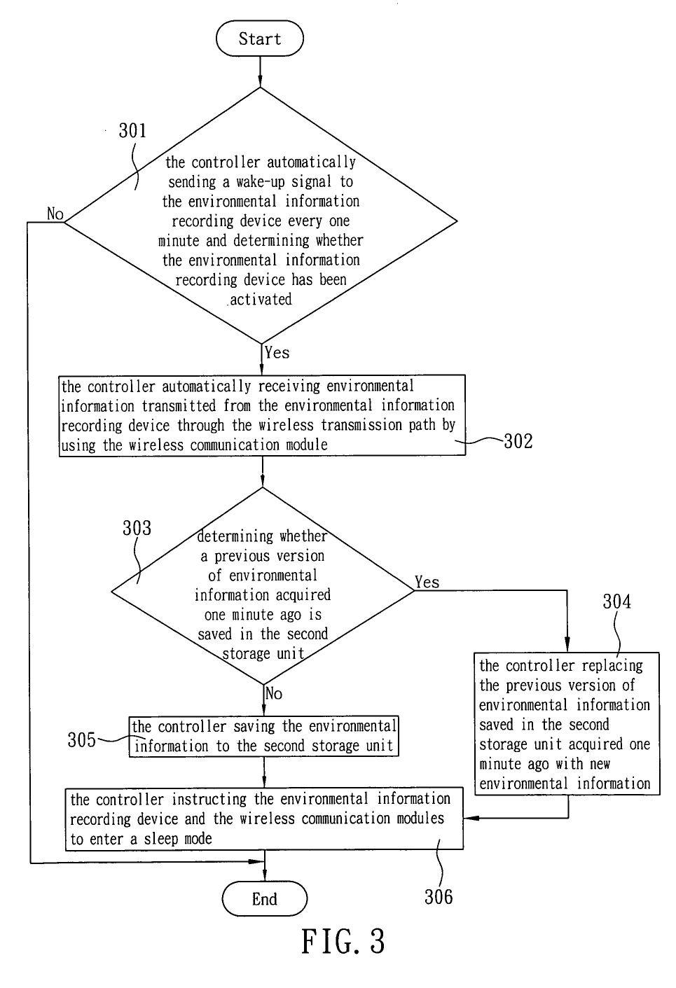

Please refer to FIGS. 1 and 3, in a second preferred embodiment of the present invention, in the case that a plug connection is established between the portable memory device 1 and the digital photographic device 16 which is not in use, the controller 12 may save the environmental information to the second storage unit 14 by following the steps of:
(301) the controller 12 automatically sending a wake-up signal to the environmental information recording device 17 through the wireless transmission path 19 by using the wireless communication module 15 every time of a predetermined period (such as one minute) and waiting for the environmental information recording device 17 to be activated, and proceeding to step (302) if it is determined that the environmental information recording device 17 has been activated or terminating the process when the environmental information recording device 17 can't be activated;
(302) the controller 12 automatically receiving environmental information transmitted from the environmental information recording device 17 through the wireless transmission path 19 by using the wireless communication module 15;
(303) the controller 12 determining whether a previous version of environmental information acquired one minute ago is saved in the second storage unit 14, and proceeding to step (304) when affirmative, otherwise proceeding to step (305);
(304) the controller 12 replacing the previous version of environmental information in the second storage unit 14 acquired one minute ago with the environmental information acquired in step (302);
(305) the controller 12 saving the environmental information acquired in step (302) to the second storage unit 14; and
(306) when stopping receiving the environmental information, the controller 12 instructing the environmental information recording device 17 and the wireless communication modules 15 and 18 to enter a sleep mode.

In said second preferred embodiment, the environmental information recording device 17 and the wireless communication modules 15 and 18 will enter a sleep mode when the controller 12 stops receiving the environmental information which prevents unnecessary power consuming and enables long-lasting use of the environmental information recording device 17. More to be mentioned, in the case that the user uses the digital photographic device 16 at a place able to receive weak GPS signals or no signal at all (such as in a cave or tunnel), the controller 12 may take the GPS information acquired right before entering that place as the GPS information when taking photos. Thus, the recording of environmental information may be quite convenient for the user and free from obstacle of any landform or location.

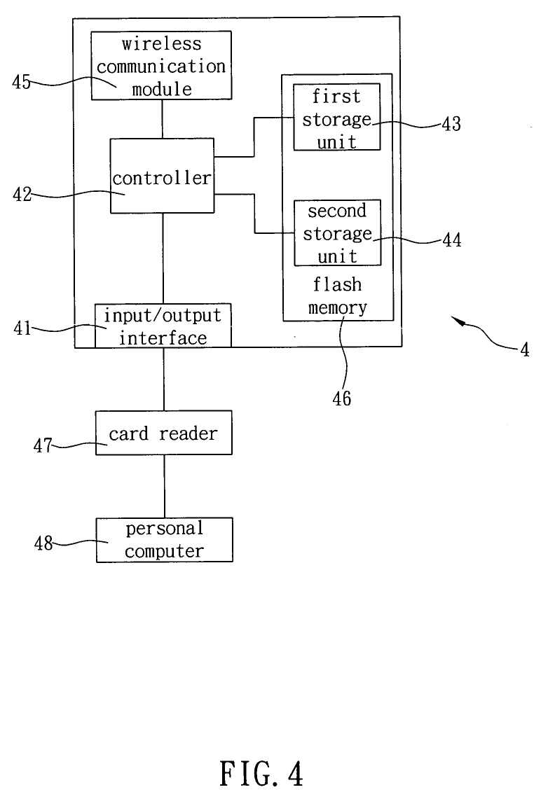

According to a third preferred embodiment of the present invention, a portable memory device with wireless communication capability is provided. Please refer to FIG. 4, the portable memory device 4 comprises an input/output interface 41, a controller 42, a first storage unit 43, a second storage unit 44 and a wireless communication module 45, wherein the controller 42 is connected with the input/output interface 41, the first and second storage units 43 and 44 and the wireless communication module 45 respectively, and the first and second storage units 43 and 44 are disposed in a flash memory 46. A plug connection is established between the input/output interface 41 and a card reader 47 which is connected with a personal computer 48. A plurality of photos and photographic information having numbers assigned according to the time are stored in the first storage unit 43 while a plurality of environmental information also having numbers assigned according to the time are stored in the second storage unit 44. When the personal computer 48 reads photos, photographic information and environmental information stored in the portable memory device 4 through the card reader 47 and the input/output interface 41, the controller 42 will integrate photos and photographic information stored in the first storage unit 43 and environmental information stored in the second storage unit 44 with the same number into new photos one by one, then transmit said new photos to the personal computer 48 through the input/output interface 41 and the card reader 47. Thus, the photos, photographic information and environmental information stored in the portable memory device 4 may be retrieved easily without extra software being installed in the personal computer 48. Besides, the photos transmitted to the personal computer 48 are rich in environmental information which enables the user to learn about environmental information while the photos were taken at a later time as well as making it more convenient and with more fun when organizing the photos.

The content stated above represents only certain preferred embodiments of the present invention and should not be regarded as limitation concerning structure and characteristic of the present invention. In present invention, said portable memory device may be a Secure Digital card (SD card for short), Compact Flash card (CF card for short), Smart Media card (SM card for short) or Extreme Digital-Picture Card (xD card for short). Said wireless communication module may be a Bluetooth module, Wireless Fidelity (Wi-Fi for short) module, ZigBee module, Z-wave module, radio frequency module or Ultra-wideband (UWB for short) module. Besides, said environmental information may comprise GPS information, temperature, humidity and illumination etc. Any variation or modification made by those skilled in the art without departing from the scope and spirit of this invention should be covered by the following claims of the present invention.

While the invention herein disclosed has been described by means of specific embodiments, numerous modifications and variations could be made thereto by those skilled in the art without departing from the scope and spirit of the invention set forth in the claims.

What is claimed is:

1. A portable memory device with wireless communication capability, comprising:
an input/output interface for connecting with a digital photographic device;
a first storage unit;
a second storage unit;
a wireless communication module for establishing a wireless transmission path with a wireless communication module of an environmental information recording device; and
a controller which is connected with said input/output interface, said storage units and said wireless communication module respectively wherein said controller is capable of receiving photos and photographic information generated by said digital photographic device through said input/output interface, saving data to said first and second storage units, and receiving environmental information transmitted from said environmental information recording device through said wireless transmission path by using said wireless communication module.

2. A portable memory device with wireless communication capability of claim 1, wherein said first and second storage units are disposed in a flash memory.

3. A portable memory device with wireless communication capability of claim 2, wherein said controller is capable of integrating photos and photographic information in said first storage unit and environmental information in said second storage unit into new photos.

4. A portable memory device with wireless communication capability of claim 3, wherein said environmental information received by said controller comprises GPS information, temperature, humidity and illumination.

5. A portable memory device with wireless communication capability of claim 4, wherein said wireless communication module is a Bluetooth module.

6. A portable memory device with wireless communication capability of claim 4, wherein said wireless communication module is a Wireless Fidelity (Wi-Fi) module.

7. A portable memory device with wireless communication capability of claim 4, wherein said wireless communication module is an Ultra-wideband (UWB) module.

8. A portable memory device with wireless communication capability of claim 4, wherein said wireless communication module is a ZigBee module.

9. A portable memory device with wireless communication capability of claim 4, wherein said wireless communication module is a Z-wave module.

10. A portable memory device with wireless communication capability of claim 4, wherein said wireless communication module is a radio frequency module.

11. A portable memory device with wireless communication capability of claim 4, wherein said wireless communication module is capable of entering a sleep mode when said controller stops receiving environmental information.

12. A portable memory device with wireless communication capability of claim 5, wherein said wireless communication module is capable of entering a sleep mode when said controller stops receiving environmental information.

13. A portable memory device with wireless communication capability of claim 6, wherein said wireless communication module is capable of entering a sleep mode when said controller stops receiving environmental information.

14. A portable memory device with wireless communication capability of claim 7, wherein said wireless communication module is capable of entering a sleep mode when said controller stops receiving environmental information.

15. A portable memory device with wireless communication capability of claim 8, wherein said wireless communication module is capable of entering a sleep mode when said controller stops receiving environmental information.

16. A portable memory device with wireless communication capability of claim 9, wherein said wireless communication module is capable of entering a sleep mode when said controller stops receiving environmental information.

17. A portable memory device with wireless communication capability of claim 10, wherein said wireless communication module is capable of entering a sleep mode when said controller stops receiving environmental information.
